(19) United States
(12) Patent Application Publication
(10) Pub. No.: US 2026/0194622 A1
(43) Pub. Date: Jul. 9, 2026

(54) DEVICE AND METHOD FOR PERFORMING RADAR-COMMUNICATION USING FREQUENCY HOPPING IN WIRELESS COMMUNICATION SYSTEM

(71) Applicants: LG ELECTRONICS INC., Seoul (KR); KOREA ADVANCED INSTITUTE OF SCIENCE AND TECHNOLOGY, Daejeon (KR)

(72) Inventors: Jihwan JANG, Seoul (KR); Songcheol HONG, Seoul (KR); Kawon HAN, Seoul (KR); Jaehoon CHUNG, Seoul (KR)

(73) Assignees: LG ELECTRONICS INC., Seoul (KR); KOREA ADVANCED INSTITUTE OF SCIENCE AND TECHNOLOGY, Daejeon (KR)

(21) Appl. No.: 19/131,617

(22) PCT Filed: Nov. 21, 2022
(86) PCT No.: PCT/KR2022/018429

§ 371 Date: May 21, 2025

(51) Int. Cl. G01S 7/00; G01S 13/58; H04L 5/00

(52) U.S. Cl. CPC G01S 7/006; G01S 13/58; H04L 5/0012

(57) ABSTRACT

Disclosed is a method for operating a communication device to perform radar-communication using frequency hopping in a wireless communication system. The method may comprise the steps of: generating at least one codeword by encoding information bits; generating modulation symbols on the basis of the at least one codeword; transmitting signals including the modulation symbols; and when reflected signals corresponding to the signals are received, performing a radar operation using the reflected signals. The modulation symbols can be transmitted throughout an allocated band using frequency hopping through a plurality of transmitters during a transmission interval, and received throughout the allocated band without frequency hopping through a plurality of receivers.

### CROSS-REFERENCE TO RELATED APPLICATION(S)

This application is the National Stage filing under 35 U.S.C. 371 of International Application No. PCT/KR2022/018429, filed on Nov. 21, 2022, the contents of which are all incorporated by reference herein in its entirety.

### TECHNICAL FIELD

The following description relates to a wireless communication system, and more particularly, to a device and method for performing radar-communication using frequency hopping in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

In the present disclosure, a device and method for effectively performing data communication and radar operations in a wireless communication system may be provided.

In the present disclosure, a device and method for performing radar operations using signals for data communication in a wireless communication system may be provided.

In the present disclosure, a device and method for performing data communication and radar operations using an analog-to-digital converter (ADC) and a digital-to-analog converter (DAC) having low sampling frequencies in a wireless communication system may be provided.

In the present disclosure, a device and method for performing radar operations without loss of channel capacity for data communication in a wireless communication system may be provided.

In the present disclosure, a device and method for performing radar operations using frequency hopping of signals in a wireless communication system may be provided.

In the present disclosure, a device and method for performing radar operations using orthogonal frequency division multiplexing (OFDM) waveforms generated by frequency hopping of signals in a wireless communication system may be provided.

In the present disclosure, a device and method for determining transmit subbands and receive subbands of data signals used for radar operations in a wireless communication system may be provided.

In the present disclosure, a device and method for determining a frequency hopping size applied to data signals used for radar operations in a wireless communication system may be provided.

The technical objectives of the present disclosure are not limited to the matters described above, and other technical problems not mentioned herein may be considered by those skilled in the art to which the technical configuration of the present disclosure applies from the embodiments described hereinafter.

According to an embodiment of the present disclosure, a method of operating a communication device in a wireless communication system, the method may include: generating at least one codeword by encoding information bits; generating modulation symbols based on the at least one codeword; transmitting signals including the modulation symbols; if receiving reflected signals related to the signals, performing a radar operation using the reflected signals. For example, wherein the modulation symbols are transmitted by frequency hopping in all allocated bands through multiple transmitters during a transmission interval, and are received in all allocated bands without frequency hopping through multiple receivers.

According to an embodiment of the present disclosure, a communication device in a wireless communication system, the communication device may include: a transceiver including multiple transmitters and multiple receivers; and a processor connected to the transceiver, wherein the processor is configured to perform operations may include: generating at least one codeword by encoding information bits; generating modulation symbols based on the at least one codeword; transmitting signals including the modulation symbols; if receiving reflected signals related to the signals, performing a radar operation using the reflected signals. For example, wherein the modulation symbols are transmitted by frequency hopping in all allocated bands through multiple transmitters during a transmission interval, and are received in all allocated bands without frequency hopping through multiple receivers.

According to an embodiment of the present disclosure, a communication device may include: at least one processor; a processor connected to the transceiver, at least one computer memory connected to the at least one processor and storing instructions that, based on being executed by the at least one processor, cause the device to perform operations, wherein the operations may include: generating at least one codeword by encoding information bits; generating modulation symbols based on the at least one codeword; transmitting signals including the modulation symbols; if receiving reflected signals related to the signals, performing a radar operation using the reflected signals. For example, wherein the modulation symbols are transmitted by frequency hopping in all allocated bands through multiple transmitters during a transmission interval, and are received in all allocated bands without frequency hopping through multiple receivers.

According to an embodiment of the present disclosure, a non-transitory computer-readable medium storing at least one instruction, comprising the at least one instruction being executable by a processor, wherein the at least one instruction is configured to perform operations may include: generating at least one codeword by encoding information bits; generating modulation symbols based on the at least one codeword; transmitting signals including the modulation symbols; if receiving reflected signals related to the signals, performing a radar operation using the reflected signals, For example, wherein the modulation symbols are transmitted by frequency hopping in all allocated bands through multiple transmitters during a transmission interval, and are received in all allocated bands without frequency hopping through multiple receivers.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, radar operations may be effectively performed using signals for data communication.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 shows a stepped-carrier OFDM scheme for implementing MIMO (multiple input multiple output) OFDM (orthogonal frequency division multiplexing) radar.

FIG. 12 shows a linear frequency-modulated OFDM scheme for implementing MIMO OFDM radar.

FIG. 13 shows a frequency comb OFDM scheme for implementing MIMO OFDM radar.

FIG. 14 shows a concept of radar-communication operation according to an embodiment of the present disclosure.

FIG. 15 shows an example of a signal transmission pattern according to an OFDM waveform according to an embodiment of the present disclosure.

FIG. 16 shows an example of a signal reception pattern according to an OFDM waveform according to an embodiment of the present disclosure.

FIGS. 17a and 17b show examples of the operation of transmitters and receivers according to an OFDM waveform according to an embodiment of the present disclosure.

FIG. 18 shows an example of a MIMO antenna array according to an embodiment of the present disclosure.

FIG. 19 shows an example of time-frequency resource allocation for a virtual antenna array according to an embodiment of the present disclosure.

FIG. 20 shows an example of time-frequency resource allocation for virtual receive array elements according to an embodiment of the present disclosure.

FIG. 21 shows an example of a procedure for performing communication and radar operations according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

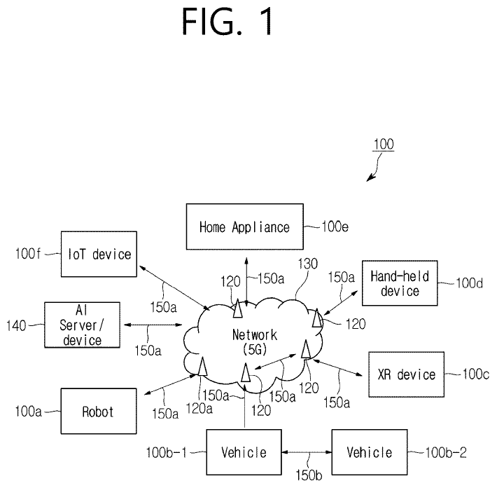

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100 a, vehicles 100 b-1 and 100 b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

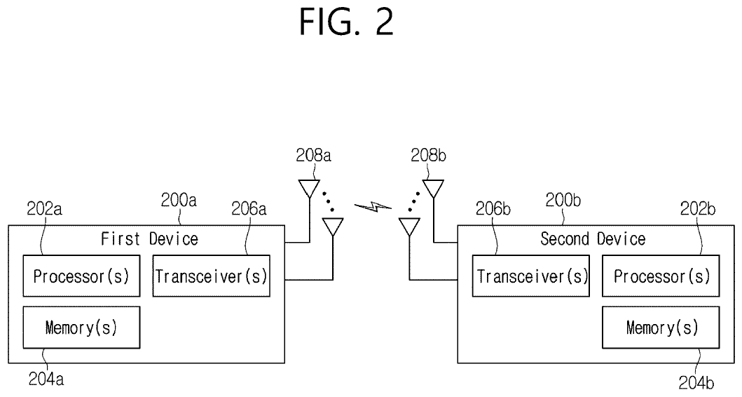

FIG. 2 shows an example of a wireless device applicable to the present disclosure.

Referring to FIG. 2, a first wireless device 200a and a second wireless device 200b may transmit and receive radio signals through various radio access technologies (e.g., LTE or NR). Here, (the first wireless device 200a, the second wireless device 200b) may correspond to (the wireless device 100x, the base station 120) and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR).

The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

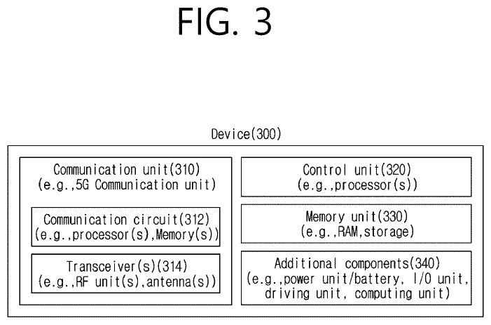

FIG. 3 shows another example of a wireless device applicable to the present disclosure. Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

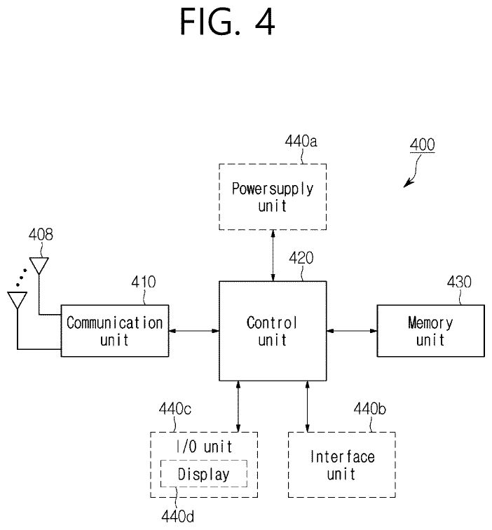

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

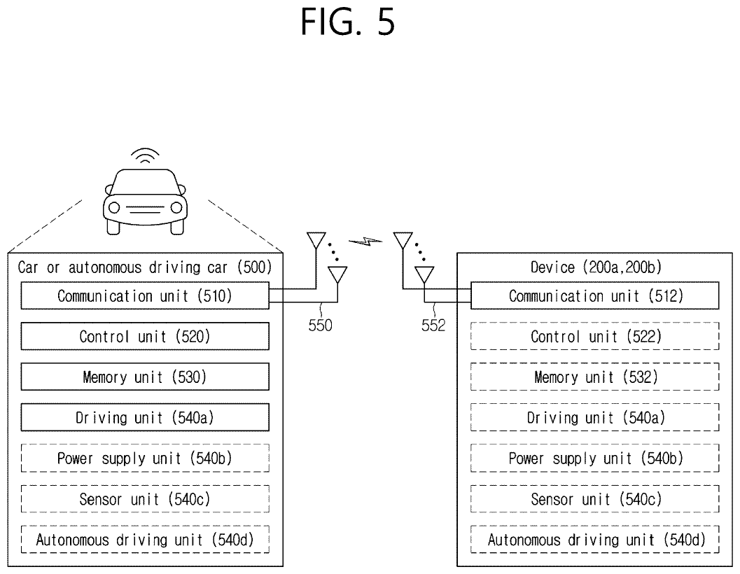

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

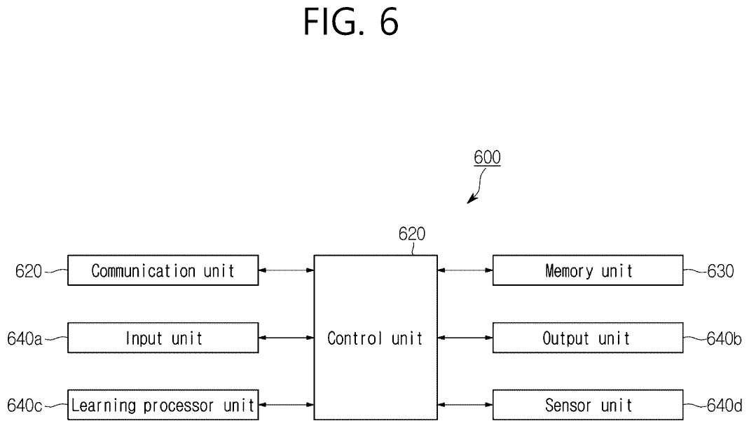

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

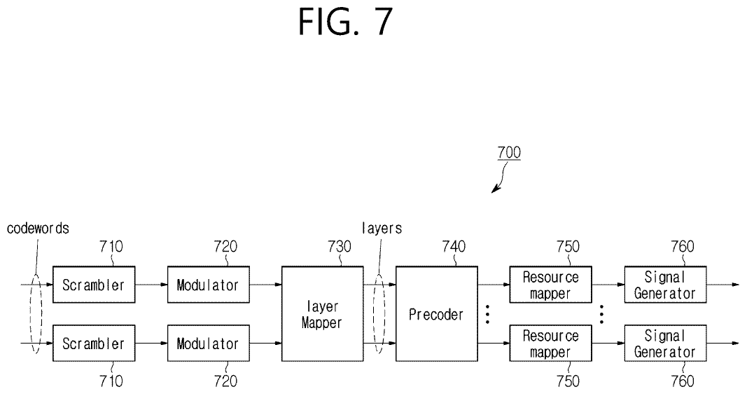

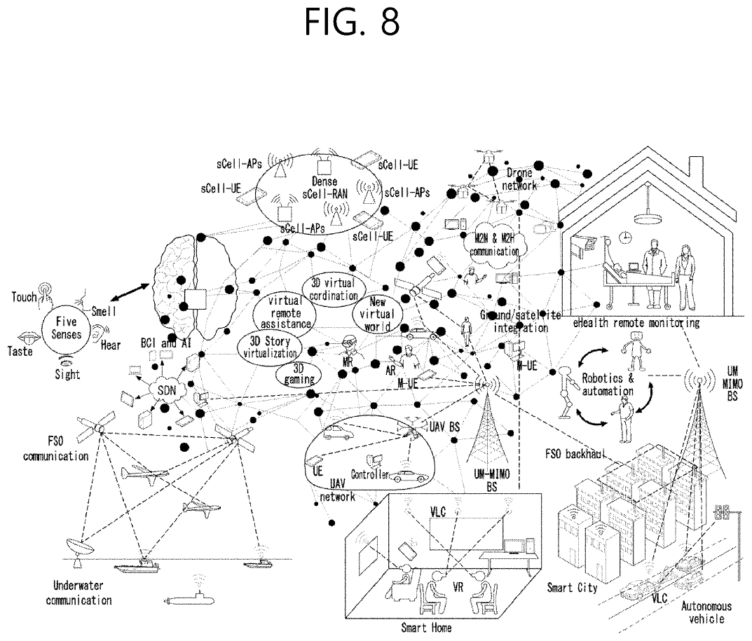

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

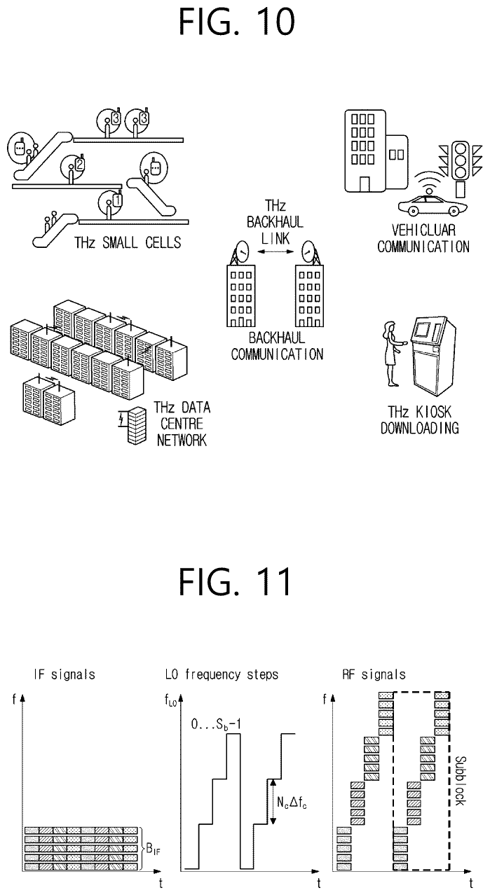

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### —Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a DNN for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

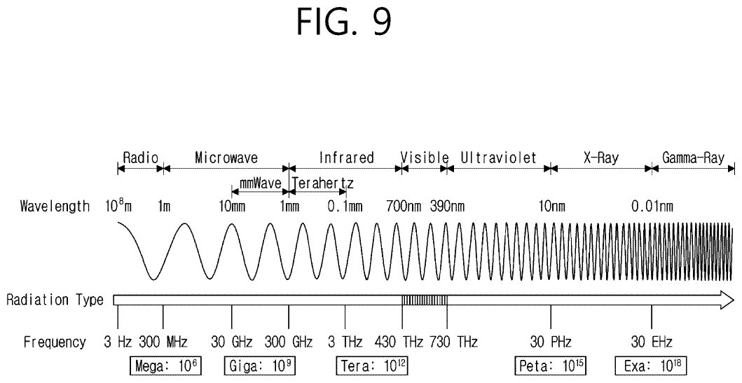

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Detailed Embodiments of the Present Disclosure

The present disclosure relates to signals and operation thereof used in a system supporting wireless communication and radar sensing. The present disclosure describes a technology to enable wireless communication and radar operations by utilizing the same system hardware and frequency resources. Moreover, the present disclosure may overcome limited hardware performance, enable radar sensing with high resolution, and secure communication capacity without wasted frequency resources. The present disclosure may be used to build a wireless radar-communication network applicable not only to existing various communication systems but also to 6G (6th generation) and beyond 6G systems.

Recently, digital radar capable of embedding data into radar waveforms, rather than conventional analog radar such as frequency modulated continuous wave (FMCW) radar, is gaining attention. Phase-modulated continuous wave (PMCW) radar and OFDM radar employing OFDM waveforms widely used in traditional communications are classified as digital radars. Digital radar has advantages such as simultaneous use in radar sensing and communication, robustness against interference from other radar sensors, and flexible waveform manipulation due to digital-domain signal generation.

Digital OFDM radar has advantages over analog radar, especially from the perspective of radar-communication integration. However, digital radar has the disadvantage of being more difficult to implement compared to analog radar. In particular, when using wide-bandwidth signals to achieve high resolution, high performance is required for the digital-to-analog converter (DAC) generating waveforms, analog-to-digital converter (ADC) digitizing received signals, and baseband amplifiers and filters supporting wide bandwidths. In other words, high-resolution digital radar implementation requires DACs and ADCs operating at high sampling frequencies, affecting signal processing circuits that must handle large data amounts simultaneously.

Several conventional methods have been proposed to implement high-resolution MIMO OFDM radar while utilizing ADCs and DACs with low sampling rates.

The first method is a stepped-carrier OFDM scheme as shown in FIG. 11. FIG. 11 shows a stepped-carrier OFDM scheme for implementing MIMO OFDM radar. Referring to FIG. 11, a wide-bandwidth OFDM signal is divided into sub-bands and transmitted differentially over time. By stepping the local oscillator (LO) of the transmitter and receiver to transmit and receive each sub-band differentially over time, the sampling rates of ADC and DAC can be reduced to the bandwidth of the sub-band. By integrally processing the divided transmitted sub-band signals at the receiver, radar range resolution equivalent to the total bandwidth can be obtained. However, since the stepped-carrier OFDM scheme employs time-interleaving of signals, DOPPLER unambiguity of radar decreases. Here, Doppler unambiguity indicates how reliable the measured Doppler value is; higher Doppler unambiguity corresponds to smaller measurement error. Moreover, when applied to MIMO radar, subcarrier-interleaving methods are employed, resulting in decreased range unambiguity. Here, range unambiguity refers to the maximum possible range in which a target can be located; larger range unambiguity corresponds to smaller error ranges.

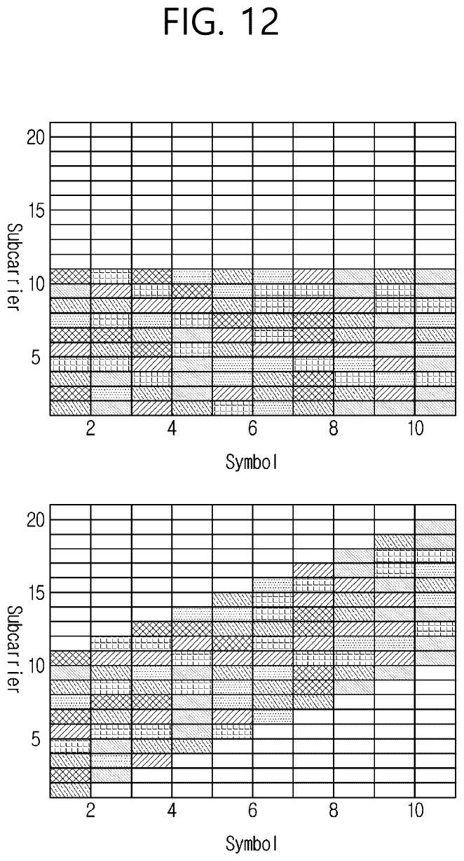

The second method is a linear frequency-modulated OFDM scheme that mixes an OFDM signal with an FMCW signal before transmission. FIG. 12 shows a linear frequency-modulated OFDM scheme for implementing MIMO OFDM radar. Although similar to the stepped-carrier OFDM scheme, stepping in stepped-carrier OFDM is performed for each symbol duration, whereas the method providing additional modulation using FMCW signals increases the LO frequency linearly. The linear frequency-modulated OFDM scheme utilizes the wide bandwidth of FMCW, thus providing high range resolution and achieving high Doppler unambiguity by using short symbol durations of OFDM signals. However, the linear frequency-modulated OFDM method has design limitations since the intermediate frequency (IF) signal band of the FMCW must not overlap with the OFDM signal, and there is a problem of ghost targets due to the presence of two modulated signals.

The main reason the above two OFDM waveforms (e.g., stepped-carrier OFDM and linear frequency-modulated OFDM) are unsuitable as radar-communication integrated signals is that the bandwidth of the simultaneously transmitted signals within a symbol duration is reduced compared to the total utilized bandwidth. That is, when applying these two methods to communication, the channel capacity decreases, making practical application to radar-communication integrated systems difficult.

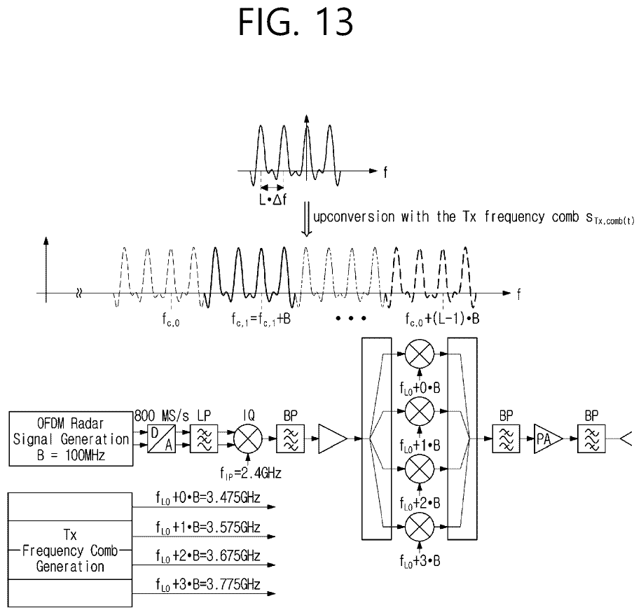

The third method is the frequency comb OFDM scheme. The frequency comb OFDM scheme was proposed to achieve high range resolution while using ADCs and DACs with low sampling frequencies. FIG. 13 shows a frequency comb OFDM scheme for implementing MIMO OFDM radar. As shown in FIG. 13, the frequency comb OFDM scheme divides the bandwidth of transmitted and received signals into multiple sub-bands by employing multiple local oscillators (LOs) at the hardware level. Since each sub-band is utilized without time-interleaving, higher Doppler unambiguity can be achieved compared to the stepped-carrier OFDM scheme. Additionally, since the bandwidth of signals transmitted within a symbol duration equals the entire bandwidth, there is no loss of communication capacity even when applied to radar-communication integrated systems. However, when applying frequency comb OFDM waveforms to MIMO radar, a drawback arises in the reduction of range unambiguity. Moreover, due to the very high hardware complexity required to simultaneously mix, transmit, and receive multiple sub-bands in parallel, implementation is difficult.

The present disclosure proposes a frequency-hopping MIMO OFDM waveform that achieves high radar range resolution using ADCs and DACs with low sampling frequencies, while preventing the loss of communication capacity. According to embodiments described below, high radar range resolution is achieved without loss of range unambiguity due to MIMO operation, and the hardware structure required for implementation is very simple.

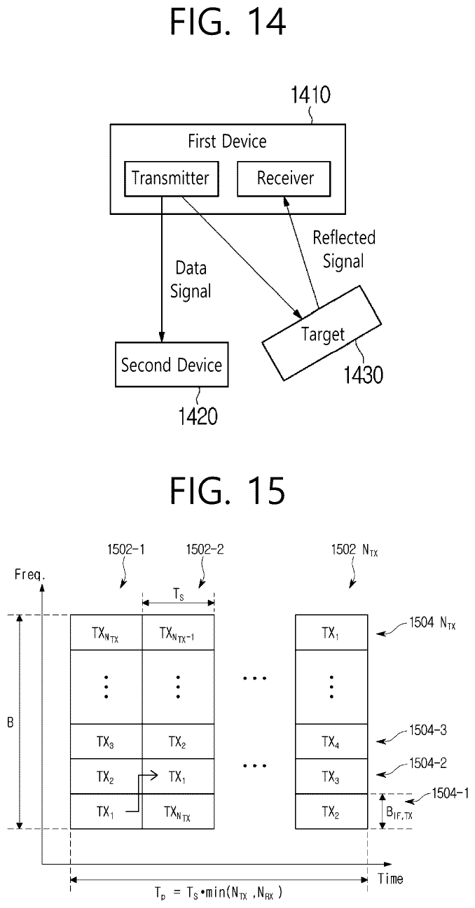

First, the concepts of radar operations and communication operations in a radar-communication system are as follows. FIG. 14 shows the concept of radar-communication operations according to an embodiment of the present disclosure. FIG. 14 illustrates a scenario where a first device (1410) having radar functionality communicates with a second device (1420) while sensing a target (1430).

Referring to FIG. 14, the first device (1410) includes a transmitter and a receiver, and transmits a data signal using the transmitter. The data signal includes data and/or information intended to be transmitted to the second device (1420). The second device (1420) communicates with the first device (1410) by receiving the data signal. In other words, the data signal delivers data and/or information to the second device (1420).

Moreover, the data signal may be reflected by the target (1430). The signal reflected by the target (1430) is received by the receiver of the first device (1410). In other words, the first device (1410) may receive, through the receiver, a reflected signal corresponding to the data signal transmitted by the transmitter. For this purpose, the transmitter and receiver of the first device (1410) may operate simultaneously in a full duplex manner. The first device (1410) may perform a radar operation for sensing the target (1430) using the reflected signal.

As described above, a device (e.g., the first device (1410)) according to various embodiments of the present disclosure may perform radar operations using data signals instead of signals specifically designed for radar sensing. Accordingly, communication operations and radar operations may be performed using the same signals. In this case, additional processing may be performed during data signal generation for its use as a radar signal, as necessary. In FIG. 14, although the target device (1430) is described as a separate device from the second device (1420) performing communication, the second device (1420) may itself become the target of radar operations, depending on the circumstances.

The frequency-hopping MIMO OFDM waveform and the operation of transmitters and receivers thereof are described as follows. The frequency-hopping MIMO OFDM waveform according to various embodiments, from transmission and reception perspectives, is described as follows.

FIG. 15 shows an example of a signal transmission pattern according to an OFDM waveform according to an embodiment of the present disclosure. Referring to FIG. 15, when the number of transmit channels is N_{TX}, the device divides the total OFDM bandwidth B into N_{TX} sub-bands (1504-1 to 1504-N_{TX}) and allocates each sub-band (1504-1 to 1504-N_{TX}) to a transmit channel. The device includes multiple transmit antennas enabling MIMO operation, and multiple transmitters connected to the multiple transmit antennas. Here, a transmitter may be understood as a transmit chain. In other words, each transmitter included in the device transmits an OFDM sub-band signal having a transmit sub-band bandwidth B_{IF,TX}. The DAC bandwidth B_{IF,TX} of each transmitter may be expressed as in the following [Equation 1].

$${B}_{IF , TX} = \frac{B}{{N}_{TX}} \qquad [ Equation 1 ]$$

In [Equation 1], B_{IF,TX} represents the DAC bandwidth of the transmitter, N_{TX} represents the number of transmit sub-bands, and B denotes the total given bandwidth.

Further, after transmitting a sub-band on each transmit channel during one OFDM symbol duration T_{S}, the transmitter hops frequency by Δf_{H} in the subsequent symbol duration, transmitting signals on a different-frequency sub-band. Here, the frequency hopping size Δf_{H} may be determined as in Equation 2 below.

$$Δ {f}_{H} = max ( {B}_{IF , TX} , {B}_{IF , RX} ) \qquad [ Equation 2 ]$$

In [Equation 2], Δf_{H} represents the frequency hopping size, B_{IF,TX} is the DAC bandwidth of the transmitter, and B_{IF,RX} is the ADC bandwidth of the receiver.

In order to achieve the same effect even if the number of available channels for transmission and reception differ, the frequency hopping size is determined based on the larger of the transmit bandwidth and the receive bandwidth. In this case, if the number of available transmit channels and the number of available receive channels have an integer multiple relationship of one or greater, the sub-band hopping interval may be determined as an integer of two or more sub-bands. For example, if the receiver's ADC bandwidth is twice the transmitter's DAC bandwidth, the transmitter may sequentially transmit signals in the n-th sub-band, the (n+2)-th sub-band, and the (n+4)-th sub-band over consecutive symbol durations according to frequency hopping.

Thus, the transmitter transmits signals while frequency hopping during a transmission interval Tₚ that includes all symbol intervals (1502-1 to 1502-N_{TX}). Here, the transmission interval Tₚ is determined to allow all transmit channels to transmit signals in all sub-bands. That is, referring to FIG. 15, by observing only the frequency band corresponding to any one sub-band, it can be confirmed that signals from all transmitters have been transmitted during the transmission interval. This is to allow each receiver on all receive channels to receive signals from all transmit channels. Therefore, the transmission interval Tₚ may be determined as in the following [Equation 3].

$${T}_{p} = {T}_{S} \cdot min ( {N}_{TX} , {N}_{RX} ) \qquad [ Equation 3 ]$$

In [Equation 3], Tₚ represents the transmission interval, T_{S} represents the symbol interval, N_{TX} represents the number of transmit sub-bands, and N_{RX} represents the number of receive sub-bands.

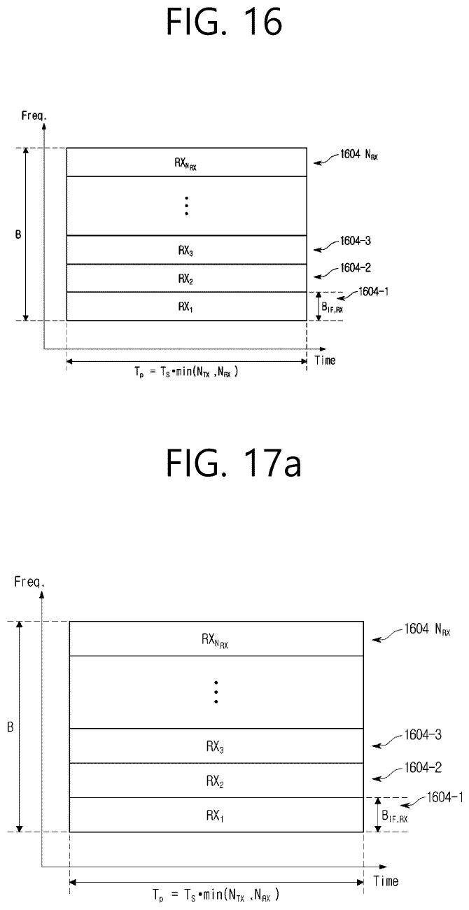

FIG. 16 shows an example of a signal reception pattern according to an OFDM waveform according to an embodiment of the present disclosure. In the case of reception, if the total number of receivers is NRX, the device divides the total OFDM signal bandwidth B into N_{RX} sub-bands (1604-1 to 1604-N_{RX}) and assigns the sub-bands (1604-1 to 1604-N_{RX}) to respective receive channels. The device includes multiple receive antennas enabling MIMO operation, and multiple receivers connected to the multiple receive antennas. Here, a receiver may be understood as a receive chain. At this time, signals corresponding to the bandwidth B_{IF,RX} of each receiver included in the device are received during the entire symbol interval Tₚ. The bandwidth B_{IF,RX} of each receiver may be expressed as in [Equation 4].

$${B}_{IF , RX} = \frac{B}{{N}_{RX}} \qquad [ Equation 4 ]$$

In [Equation 4], B_{IF,RX} represents the ADC bandwidth of the receiver, N_{RX} represents the number of receive sub-bands, and B represents the total given bandwidth.

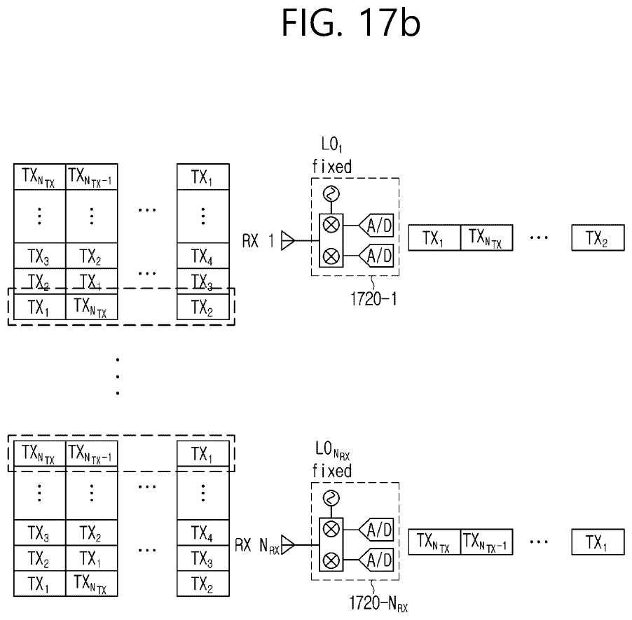

FIGS. 17a and 17b show examples of operation of transmitters and receivers according to an OFDM waveform according to an embodiment of the present disclosure.

Referring to FIG. 17a, the device includes N_{TX} transmitters (1710-1 to 1710-N_{TX}), and transmits signals TX₁ to TX_{N_TX} through the transmitters (1710-1 to 1710-N_{TX}). Each of the transmitters (1710-1 to 1710-N_{TX}) includes DACs for I-channels and Q-channels, mixers, and a local oscillator (LO) supplying frequency signals to the mixers. To form a transmission pattern as shown in FIG. 15, the transmitters (1710-1 to 1710-N_{TX}) start transmitting in different sub-bands and repeatedly transmit the same signals across multiple sub-bands during the transmission interval. For example, NIX sub-bands may be used, and each transmitter (1710-1 to 1710-N_{TX}) may perform one transmission per sub-band over multiple transmissions.

Referring to FIG. 17b, the device includes N_{RX} receivers (1720-1 to 1720-N_{RX}), and receives signals TX₁ to TX_{N_TX} through the receivers (1720-1 to 1720-N_{RX}). Each of the receivers (1720-1 to 1720-N_{RX}) includes mixers for I-channels and Q-channels, ADCs, and a local oscillator (LO) supplying frequency signals to the mixers. To form a reception pattern as shown in FIG. 16, the receivers (1720-1 to 1720-N_{RX}) perform reception in different sub-bands during the transmission interval. For example, N_{RX} sub-bands may be used, and each receiver (1720-1 to 1720-N_{RX}) sequentially receives different signals in one of the sub-bands.

The frequency-hopping MIMO OFDM waveform, transmitter and receiver operations according to the above embodiments provide radar range resolution ΔR=c/(2B) corresponding to the entire OFDM bandwidth B. Additionally, the sampling bandwidths of the DAC and ADC used for signal generation and reception at each transmitter and receiver are reduced to B_{IF,TX} and B_{IF,RX}, respectively. Moreover, since subcarrier interleaving is not used for MIMO operation, there is no loss in range unambiguity. Furthermore, when using waveforms according to the above-described embodiments, the bandwidth of the transmitted signal during a single symbol interval remains B, thus preventing loss of channel capacity.

In the above-described embodiments, the frequency hopping size is determined as the larger bandwidth between the transmit sub-band bandwidth and the receive sub-band bandwidth. However, according to other embodiments, the frequency hopping size may be determined as an integer multiple of the larger bandwidth between the transmit sub-band bandwidth and the receive sub-band bandwidth. Consequently, as long as each signal is transmitted at least once in every sub-band during the transmission interval, the frequency hopping size may be determined to be greater than the larger bandwidth between the transmit and receive sub-bands. Further, the frequency hopping size may be controlled to vary over time. Under the condition that each signal is transmitted at least once in every sub-band during the transmission interval, the frequency hopping size may be determined according to a predetermined pattern.

Based on the aforementioned signal patterns, a virtual antenna array of the frequency-hopping MIMO OFDM radar may be determined.

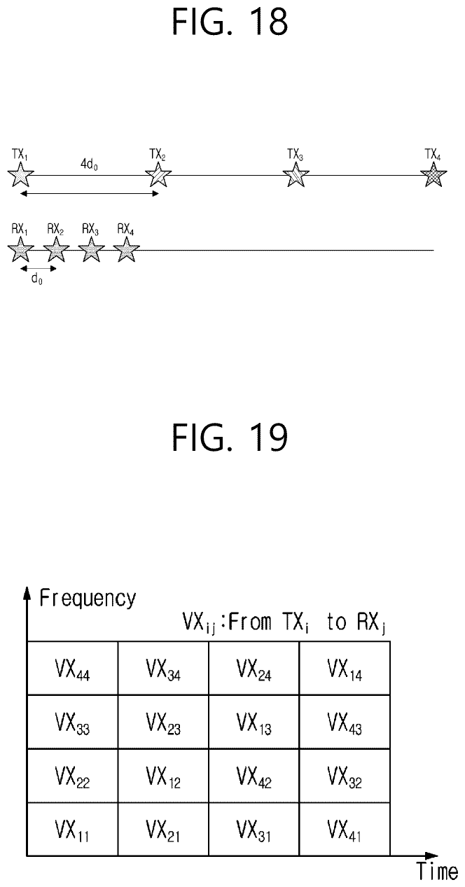

FIG. 18 shows an example of a MIMO antenna array according to an embodiment of the present disclosure. Specifically, FIG. 18 shows a MIMO antenna array consisting of four transmit channels and four receive channels. Each antenna may be understood as an individual transmit or receive channel. Referring to FIG. 18, according to an embodiment, transmit antenna elements may be arranged at intervals of 4d₀, and receive antenna elements may be arranged at intervals of d₀.

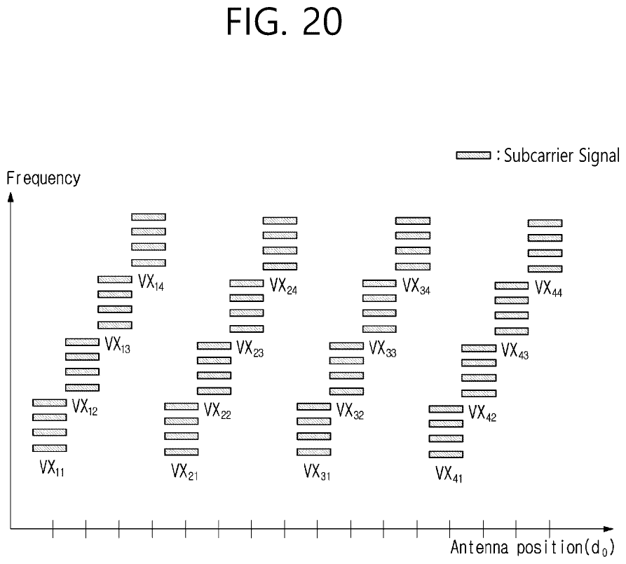

When a virtual receive array element formed by a signal transmitted from an i-th transmitter, reflected by an object, and received by a j-th receiver is denoted by VXᵢⱼ, the time-frequency resources allocated to each VXᵢⱼ using the frequency-hopping MIMO OFDM waveform described above may be expressed as shown in FIG. 19. FIG. 19 shows an example of time-frequency resource allocation for a virtual antenna array according to an embodiment of the present disclosure. Referring to FIG. 19, virtual receive array elements formed by different pairs of transmitters and receivers are allocated to corresponding sub-band frequencies. In other words, although the device uses four physical receive antenna elements, when forming a virtual receive array based on the aforementioned signal patterns, the four physical receive antenna elements may be effectively utilized as a 4×4 receive array. This may be represented as shown in FIG. 20 across the entire virtual receive array.

FIG. 20 shows an example of time-frequency resource allocation for virtual receive array elements according to an embodiment of the present disclosure. FIG. 20 shows the result of converting the time axis into antenna positions in a virtual receive array, as shown in FIG. 19. That is, signals received at different times in FIG. 19 are treated as signals received by different antenna elements in FIG. 20. Referring to FIG. 20, positions of virtual receive array elements are determined based on relative positions of different transmitter and receiver pairs, and corresponding sub-bands are allocated to these virtual receive array elements. Accordingly, as shown in FIG. 20, signal reception results may be obtained for sixteen virtual receive antenna elements arranged at intervals of do. When estimating radar targets by integrating all virtual receive array elements, high range resolution may be achieved since the entire bandwidth B is utilized.

As described in the various embodiments above, in a MIMO OFDM system for radar-communication, transmitters transmit sub-band OFDM signals in different frequency bands within one symbol interval, and each transmitter may perform frequency hopping over time to avoid overlapping of transmitted signal frequency bands. Accordingly, during the entire symbol interval, all transmitters transmit signals in the frequency bands corresponding to particular sub-bands. Each receiver receives sub-band OFDM signals in different frequency bands. Here, the device identifies signals received at each receiver as transmitted from specific transmitters, and forms a virtual receive array.

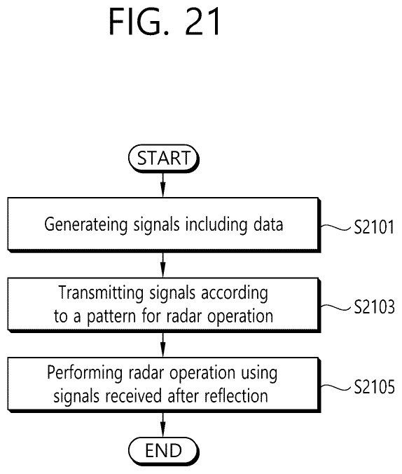

FIG. 21 shows an example of a procedure for performing communication and radar operations according to an embodiment of the present disclosure. FIG. 21 shows an operating method of a device (e.g., a base station or a user equipment (UE)).

Referring to FIG. 21, in step S2101, the device generates signals including data. The device generates signals including data for communication with another device (e.g., a UE or a base station). For example, the device may generate at least one codeword by encoding information bits, perform scrambling on bits within the at least one codeword, and generate modulation symbols by modulating the scrambled bits. That is, the device may generate signals by performing at least one operation among encoding, scrambling, and modulation. In this case, the device may generate signals according to the coding rate and modulation scheme assigned by the base station. In other words, before generating the signals, the device may perform scheduling or receive scheduling information (e.g., control signals).

In step S2103, the device transmits signals according to a pattern for radar operation. The pattern for radar operation includes transmitting signals in each sub-band and repeatedly transmitting them with frequency hopping. Here, the device may determine transmit sub-bands and receive sub-bands within the allocated bandwidth, and determine the frequency hopping size based on the number of sub-bands. In this case, the number of transmit sub-bands and the number of receive sub-bands may be determined based on the number of available transmitters and receivers. For example, the device may transmit a first signal in a first sub-band during one symbol interval, and transmit the first signal in a second sub-band during the next symbol interval.

The device performs radar operation using signals received after reflection. That is, the device receives reflected signals generated by the transmitted signals being reflected in step S2103. Here, the device may control the receivers to receive signals in their assigned receive sub-bands during the transmission interval. Then, the device forms virtual receive arrays and arranges the received signals according to these virtual receive arrays. The signals are arranged in a two-dimensional space composed of frequency and positions of virtual receive antenna elements, where the time axis corresponds to the axis of the receive antenna element positions. For example, the device arranges received signals in a virtual receive array as shown in FIG. 20. Subsequently, through radar operations, the device may detect at least one of a distance to a target object, a relative angle to the target object, and a moving speed of the target object.

According to the embodiment described with reference to FIG. 21, communication and radar operations may be performed using the same signals. Here, radar operations detect at least one of a distance to a target object, a relative angle to the target object, and a moving speed of the target object, each of which may be detected as follows.

The distance may be obtained by compressing signals arranged according to the virtual receive array along the frequency axis. Here, compression may be performed by an inverse Fourier transform operation. The angle may be obtained by compressing the signals along the antenna element position axis. Here, compression may be performed by a Fourier transform operation. In this case, the two aforementioned compression operations may be simultaneously performed by a two-dimensional Fourier transform operation. The speed may be determined based on distance values and angle values continuously detected along the time axis. That is, the device may estimate speed by repeating the distance and angle detections described above in consecutive transmission intervals, and using the sequentially detected distance values and angle values.

As described above, the present disclosure proposes a waveform that achieves high radar range resolution using ADCs and DACs with low sampling frequencies, while operating without loss of communication channel capacity in radar-communication integrated systems. Accordingly, the proposed technology enables simultaneous operation of high-performance sensing and communication in future 6G and wireless network environments. Furthermore, the proposed technology may be extended to various application areas such as sensing-aided communication and communication-aided sensing.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
generating at least one codeword by encoding information bits;
generating modulation symbols based on the at least one codeword;
transmitting signals including the modulation symbols;
performing, based on receiving reflected signals related to the signals, a radar operation using the reflected signals,
wherein the modulation symbols are transmitted by frequency hopping in all allocated bands through multiple transmitters during a transmission interval, and are received in all allocated bands without frequency hopping through multiple receivers.

2. The method of claim 1,
wherein the transmitting the signals comprises:
controlling each transmitter to repeatedly transmit the same signal by frequency hopping in all subbands in the allocated band during multiple time intervals.

3. The method of claim 1,
wherein the performing the radar operation comprises:
controlling each receiver to receive a signal on one subband during the multiple time intervals;
forming a virtual receiver array based on pairs of transmitters and receivers that transmitted and received same signal; and
generating a sensing result for an object reflecting the signals based on the virtual receiver array.

4. The method of claim 1,
wherein spacing between transmit antenna elements for transmitting the signals is an integer multiple of spacing between receive antenna elements for receiving the reflected signals.

5. The method of claim 1,
wherein the signals include a first signal and a second signal,
wherein the first signal is repeatedly transmitted through a first transmit antenna element in multiple subbands during the transmission interval,
wherein the second signal is repeatedly transmitted through a second transmit antenna element in the multiple subbands during the transmission interval.

6. The method of claim 5,
wherein the first signal is transmitted through a first subband during a first time interval and through a second subband during a second time interval in the transmission interval,
wherein the second signal is transmitted through the second subband during the first time interval and through a third subband during the second time interval.

7. The method of claim 1,
wherein the reflected signals include a first set of signals received on a first subband and a second set of signals received on a second subband,
wherein the first set of signals is received through a first receive antenna element during the transmission interval,
wherein the second set of signals is received through a second receive antenna element during the transmission interval.

8. The method of claim 7,
wherein the first set of signals includes a first signal transmitted through a first transmit antenna element during a first time interval and a second signal transmitted through a second transmit antenna element during a second time interval in the transmission interval,
wherein the second set of signals includes a second signal transmitted through the second transmit antenna element during the first time interval and a third signal transmitted through a third transmit antenna element during the second time interval.

9. The method of claim 1,
wherein each of the multiple transmitters includes a digital-to-analog converter (DAC), a mixer, and a local oscillator (LO),
wherein the DAC has a bandwidth equal to a bandwidth of a transmit subband.

10. The method of claim 1,
wherein a size of the frequency hopping is determined based on a larger bandwidth among a transmit subband bandwidth for transmitting the signals and a receive subband bandwidth for receiving the signals.

11. The method of claim 1,
wherein the transmission interval includes symbol intervals equal in a number to a smaller one of a number of the multiple transmitters and a number of the multiple receivers.

12. A communication device comprising:
a transceiver including multiple transmitters and multiple receivers; and
a processor connected to the transceiver,
wherein the processor is configured to perform operations comprising:
generating at least one codeword by encoding information bits;
generating modulation symbols based on the at least one codeword;
transmitting signals including the modulation symbols;
performing, based on receiving reflected signals related to the signals, a radar operation using the reflected signals,
wherein the modulation symbols are transmitted by frequency hopping in all allocated bands through multiple transmitters during a transmission interval, and are received in all allocated bands without frequency hopping through multiple receivers.

13. A communication device comprising:
at least one processor;
a processor connected to the transceiver,
at least one computer memory connected to the at least one processor and storing instructions that, based on being executed by the at least one processor, cause the device to perform operations,
wherein the operations comprising:
generating at least one codeword by encoding information bits;
generating modulation symbols based on the at least one codeword;
transmitting signals including the modulation symbols;
performing, based on receiving reflected signals related to the signals, a radar operation using the reflected signals,
wherein the modulation symbols are transmitted by frequency hopping in all allocated bands through multiple transmitters during a transmission interval, and are received in all allocated bands without frequency hopping through multiple receivers.

14. (canceled)
